(19) United States
(12) Patent Application Publication
(10) Pub. No.: US 2018/0229548 A1
(43) Pub. Date: Aug. 16, 2018

(54) A FOLDABLE WHEEL AND VEHICLES EQUIPPED WITH SUCH A WHEEL

(71) Applicant: Andrea MOCELLIN, San Nazario (VI) (IT)

(72) Inventor: Andrea MOCELLIN, San Nazario (VI) (IT)

(21) Appl. No.: 15/751,757

(22) PCT Filed: Sep. 1, 2016
(86) PCT No.: PCT/IB2016/055241

§ 371 Date: Feb. 9, 2018

(30) Foreign Application Priority Data
Sep. 3, 2015 (IT) 102015000048456

(51) Int. Cl. B60B 19/04; B60B 25/02; B60B 27/02; B60B 21/06

(52) U.S. Cl. CPC B60B 19/04; B60B 25/02; B60B 25/006; B60B 21/062; B60B 2900/114; B60B 27/023

(57) ABSTRACT

A foldable wheel includes a double hub, a rim with rubberized sectors, and spokes pivotly connecting each hub with the sectors of the rim. The sectors of the rim can be figured, starting from an extended condition of forming the wheel in which the hubs are mutually approached, in a collapsed condition in which the hubs are mutually spaced apart along the wheel axis. The spokes are pivoted to the hubs substantially on the wheel axis and in the collapsed condition the sectors of the rim extend longitudinally between the two hubs.

### FIELD OF THE INVENTION

The present invention regards foldable or collapsible wheels comprising a rim with rubberised sectors that can be configured, starting from an extended condition for forming the rim, in a collapsed condition for minimum overall dimension of the wheel.

### STATE OF THE PRIOR ART

Collapsible wheels are described and illustrated for example in documents U.S. Pat. No. 8,371,659, U.S. Pat. No. 8,833,864, US-2012/0032497, US-2014/0097666 and US-2015/0084398.

Foldable wheels thus made can advantageously be used, for example, for equipping foldable bicycles with the aim of reducing overall the dimensions thereof and facilitating transportation and putting it away when not being used.

The foldable wheel described in document US-2015/0084398 corresponds to the pre-characterised part of claim 1: it comprises a double hub and spokes which pivotly connect each hub with the sectors of the rim. The spokes have a fixed length and the hubs can be displaced between an approached condition, corresponding to the extended condition of the sectors in which the rim is made, and a spaced condition in which the spokes extend substantially parallel to the wheel axis and the sectors of the rim are folded.

This prior art solution reveals several drawbacks: firstly, the wheel, even in the collapsed configuration, has a considerable radial overall dimension due to the fact that the folded sectors of the rim are arranged around the spokes according to two axially spaced circumferential groups distinct from each other. Secondly, the wheel is formed by a large number of components and a plurality of articulations between the components which, besides complicating the structure and the manufacturing, also imply a considerable weight and ensuing challenges not only when it comes to moving the wheel in collapsed condition but also during the use thereof in the extended condition for example with a bicycle, due to a difficult manoeuvrability. A further drawback of this prior art collapsible wheel regards the system for locking the sectors of the wheel by the spokes in the extended condition, revealing poor resistance to impacts and thus poorly reliable in use.

Document CN-103963557A describes a collapsible wheel comprising a rim with segments, foldable rods and a central shaft suitable to be folded and unfolded.

### SUMMARY OF THE INVENTION

The object of the present invention is to overcome the aforementioned drawbacks and such object is attained thanks to a foldable wheel of the type defined in the pre-characterising part of claim 1, whose peculiar characteristic resides in that the spokes are pivoted to the hubs substantially on the wheel axis and in that in the collapsed condition the sectors of the rim extend longitudinally between the two hubs.

The pivoting of the spokes around the wheel axis enables, contrary to the case of the prior art wheel mentioned in document US-2015/0084398 in which the spokes are pivoted at the peripheries of the hubs, considerably reducing the overall radial dimensions of the wheel in the rim collapsed condition, due to the longitudinal or axial arrangement of the sectors of the rim in the collapsed condition. In addition, such arrangement advantageously enables the folded wheel to assume a general roller-like configuration due to which it can for example be dragged on the ground rolling, thus not necessarily lifted for transportation thereof.

This advantage is further amplified by the fact that, according to another characteristic of the invention, the two hubs are predisposed to receive respective lateral rollers, for example of the omni-directional type. This enables the folded wheel to be profitably used in several applications for equipping vehicles of various kinds and types such as for example trolleys, strollers, wheelchairs, scooters, trolley bags, etc.

According to a preferred embodiment of the invention, the foldable wheel according to the invention comprises an axially extensible and contractible central shaft carrying the two hubs, and the spokes are configured in groups in which each group includes a first spoke which pivotly connects a hub with a sector of the rim, and a second spoke which pivotly interconnects the other hub with said sector of the rim and it is pivoted to the first spoke in a scissor-like fashion.

In a variant, the central shaft is formed by two separable axial parts.

The sectors of the rim are preferably, though not necessarily, six.

### BRIEF DESCRIPTION OF THE DRAWINGS

The invention will now be described in detail, purely by way of non-limiting example, with reference to the attached drawings, wherein:

FIG. 1 is a lateral elevational view of a foldable wheel according to the invention, in the extended condition,

FIG. 2 is a plan view of FIG. 1,

FIG. 3 is a view analogous to FIG. 1 showing the wheel in the collapsed condition,

FIG. 4 is a plan view of FIG. 3,

FIG. 5 is a perspective view of the wheel in the extended condition,

FIG. 6 is a view analogous to FIG. 5 showing the wheel when passing from the extended condition to the collapsed condition,

FIG. 7 is a perspective view of the wheel in the collapsed condition,

FIG. 8 is a diametrical sectional view of the wheel in the extended condition, in which the rim was omitted for illustration simplicity purposes,

FIG. 9 is a view analogous to FIG. 8 when passing from the extended condition to the collapsed condition,

FIG. 10 is a view analogous to FIGS. 8 and 9 showing the collapsed condition,

FIG. 11 is a perspective view and in larger scale showing a detail of the wheel when passing from the collapsed condition to the extended condition,

FIGS. 12 and 13 are further perspective views and in larger detail analogous to FIG. 11,

FIG. 14 is a perspective view of the wheel in the extended condition in which all sectors of the rim except one were removed for illustration simplicity purposes,

FIGS. 15 and 16 are two perspective views of the wheel in collapsed condition to which auxiliary rolling elements are applied,

FIGS. 17 to 26 schematically exemplify various examples of application of the foldable wheel according to the invention,

FIG. 27 is a perspective view of a variant of the wheel in the extended condition,

FIG. 28 shows the wheel of FIG. 27 in a solely partly collapsed condition, and

FIG. 29 shows a part of FIG. 28 in larger detail from a different angle.

### DETAILED DESCRIPTION OF THE INVENTION

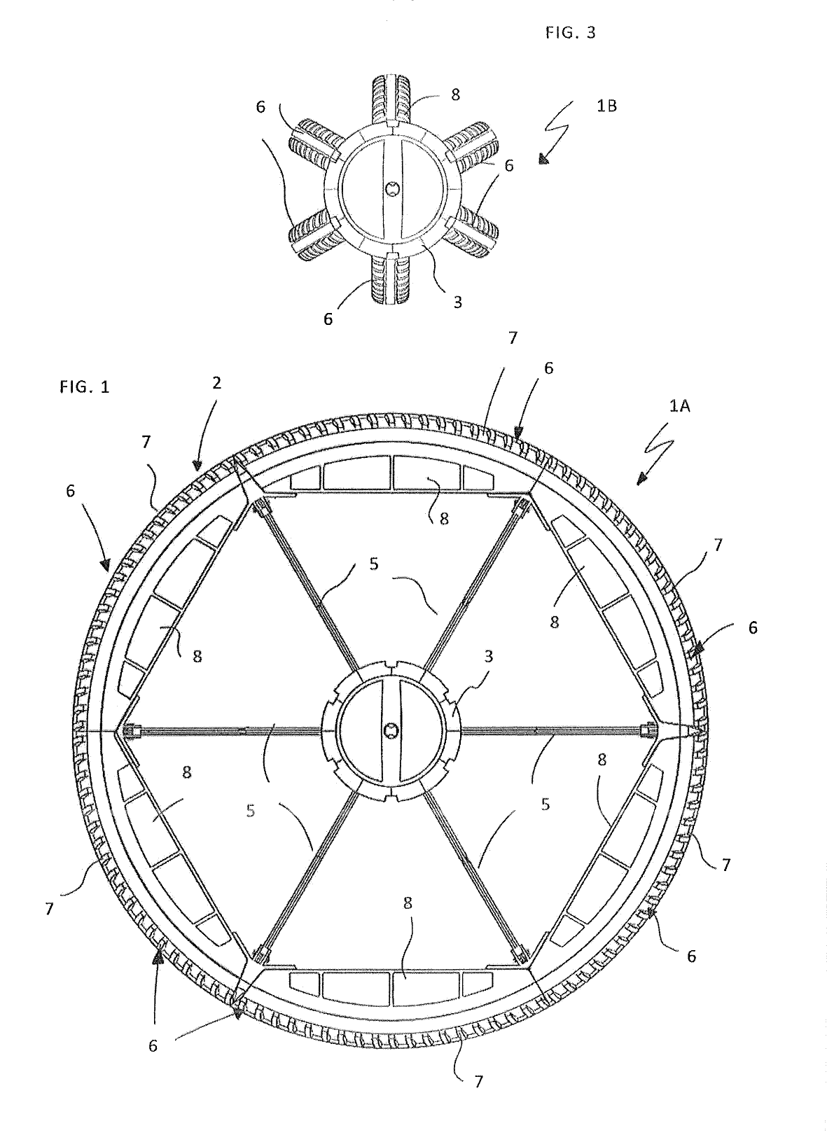

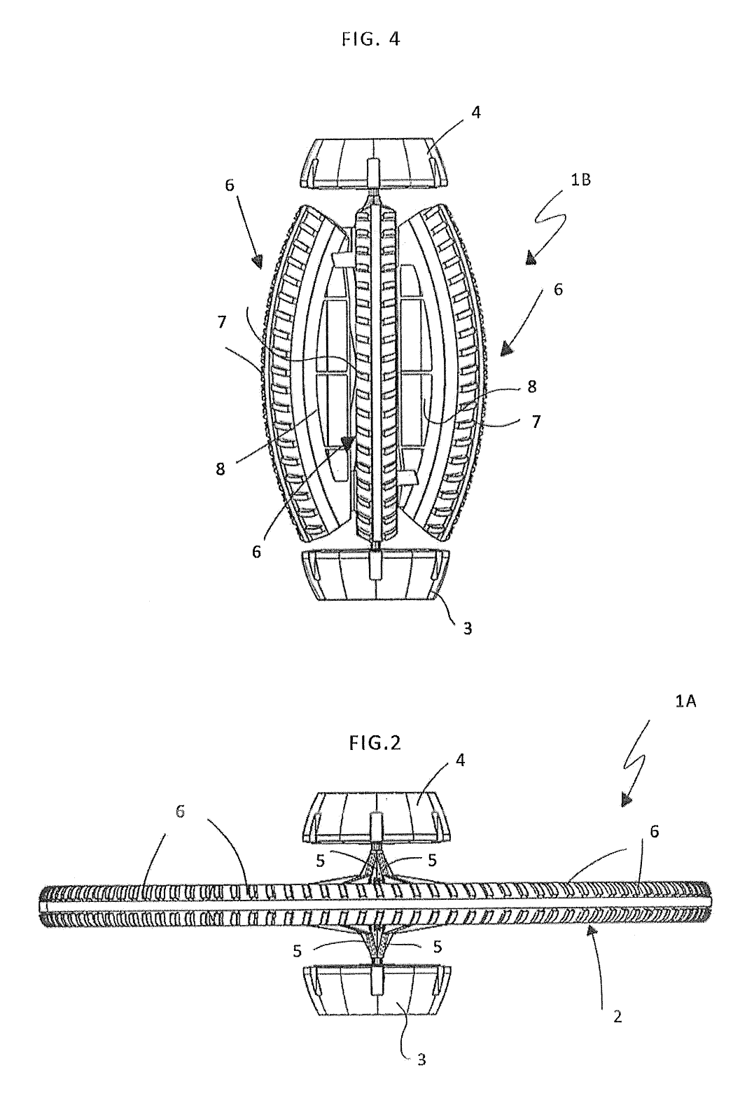

Initially with reference to FIGS. 1, 2, 8 and 14 the foldable wheel according to the invention, indicated with 1A in the extended condition of normal use thereof, essentially comprises a rubberised rim 2, a pair of coaxial hubs 3, 4 and a series of spokes generally indicated with 5 which pivotly interconnect each hub 3, 4 with the rim 2.

The rim 2 is in turn formed by a series of sectors 6 each of which includes an arched rubber portion 7 carried by a rigid support 8 which, in the extended condition of the wheel 1A, extends according to an edge of the rim 2.

In the case of the illustrated example, the sectors are six, same case applying to the group of spokes 5. However, within the present invention there may be provided for solutions with a greater number of sectors, with the aim of attaining greater compactness of the wheel in the folded condition thereof.

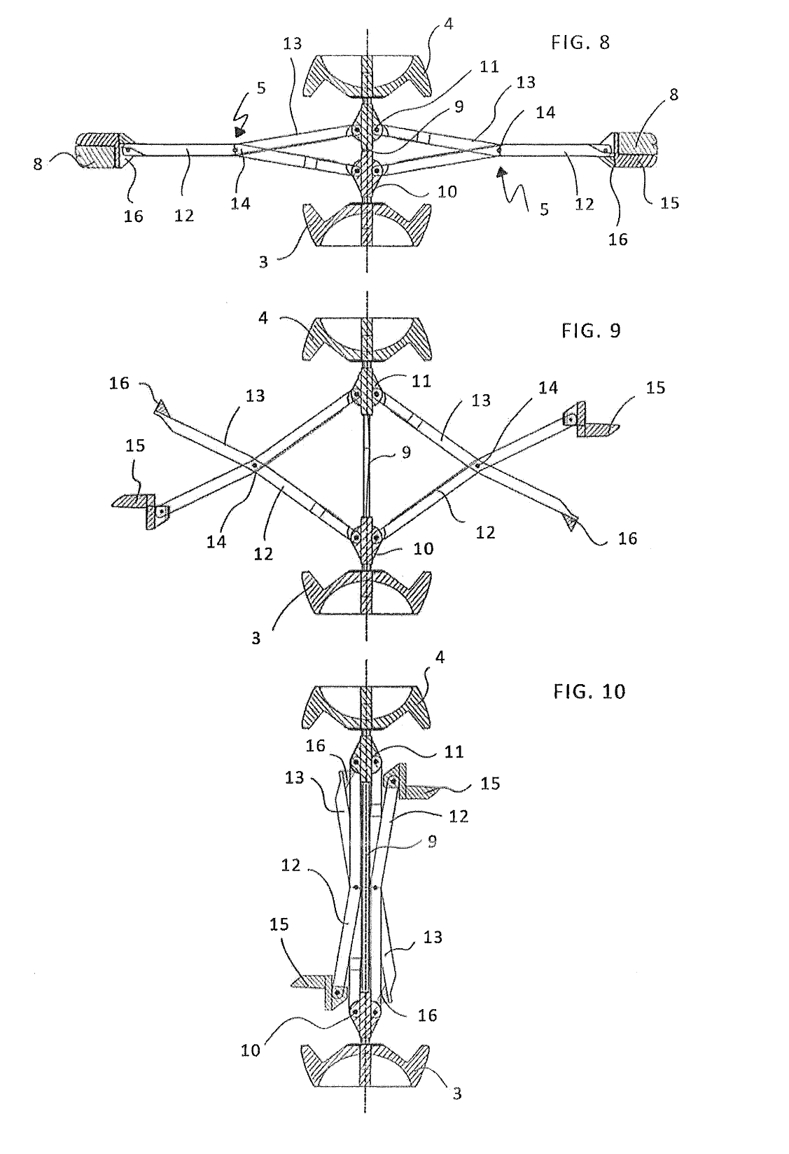

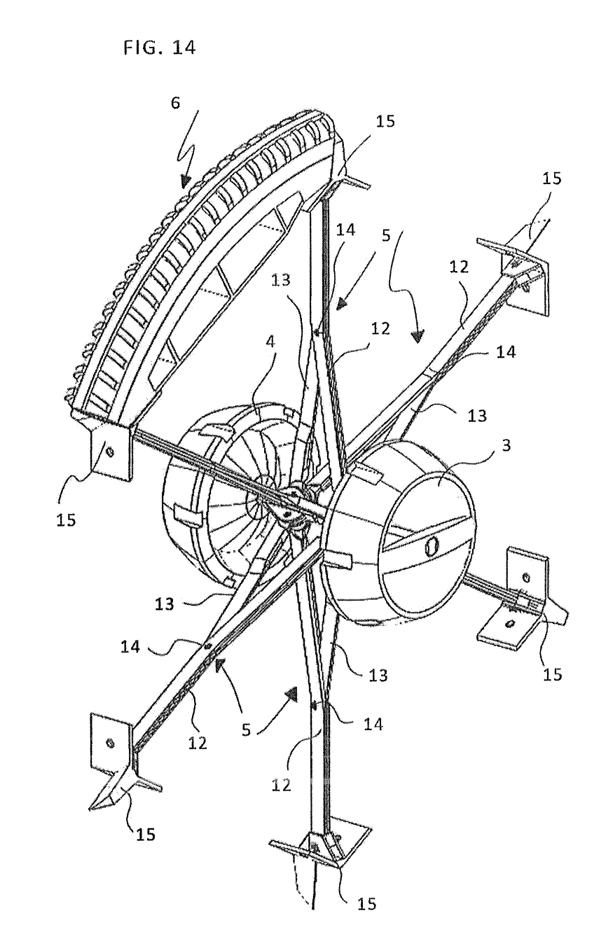

As observable in larger detail in FIGS. 8 and 14, the hubs 3, 4 are mounted on a central shaft 9, axially extensible and contractible for example in a telescopic fashion, and the spokes 5 are pivoted to respective support appendages 10, 11 of the hubs 3, 4, substantially on the wheel axis defined by the shaft 9.

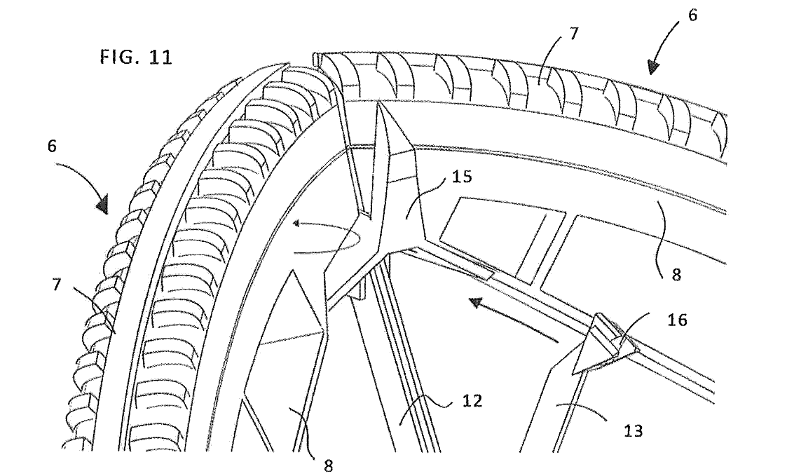

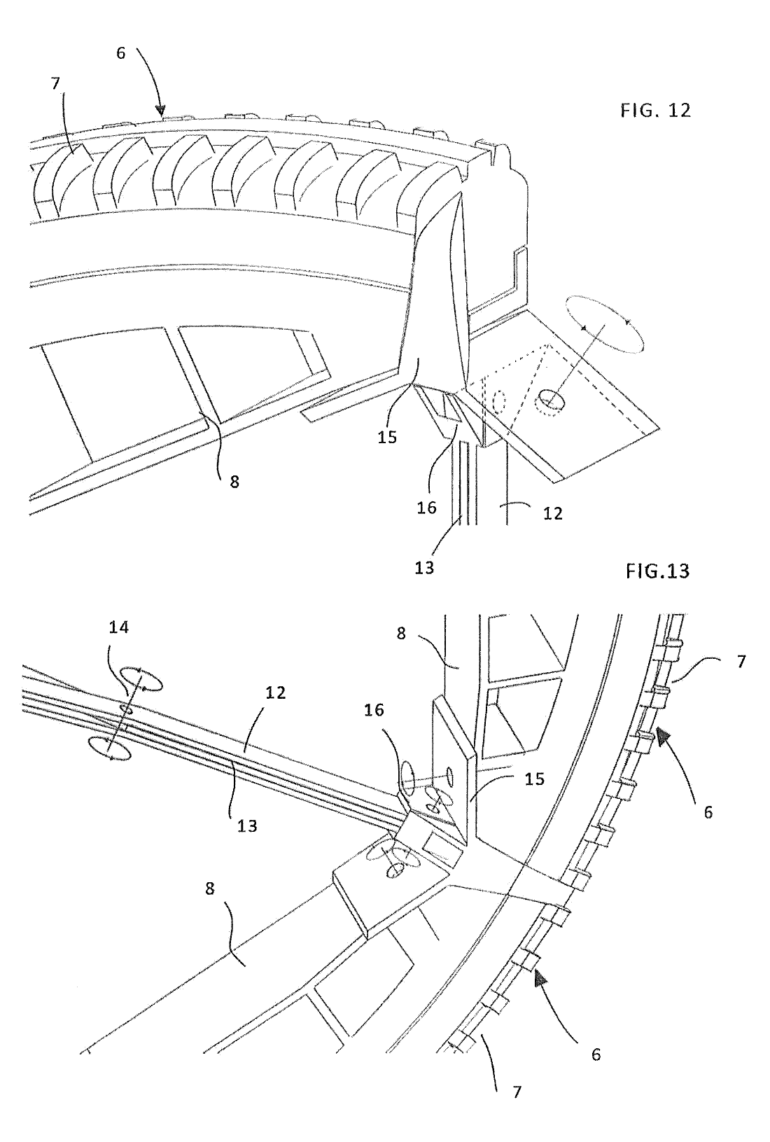

As better observable in FIGS. 8, 9 and 14 each group of spokes 5 comprises a first spoke 12 whose radially internal end is pivoted to the support 10 of the hub 3 and a spoke 13 whose internal end is pivoted to the support 11 of the hub 4. The spokes 12 and 13 are centrally pivoted to each other in a scissor-like fashion 14, and carry, at the respective radially external ends, locking members 15, 16 shaped as represented in detail in FIGS. 11-13 so as to cooperate with the ends of the supports 8 of the sectors 6 of the rim 2. In particular, the members 15 are configured to as to enable the rotation of the sectors 6 from closed to open with two distinct rotational axes for the respective contiguous sectors 6, as illustrated in FIG. 13, besides rotating on the relative spoke 13 so as to maintain a parallelism condition with the corresponding hub when unfolding the wheel. The members 16 act in a manner such to stably and rigidly hold the rim 2 in the extended condition.

FIGS. 3 and 4 represent the foldable wheel in the collapsed condition, indicated with 1B: in such configuration, the hubs 3, 4 are axially spaced from each other, the groups of spokes 5 extend substantially axially along the central shaft 9, adjacent with respect thereto, and the sectors 6 of the wheel 2 also extend longitudinally between the two hubs 3, 4, externally to the groups of rays 5.

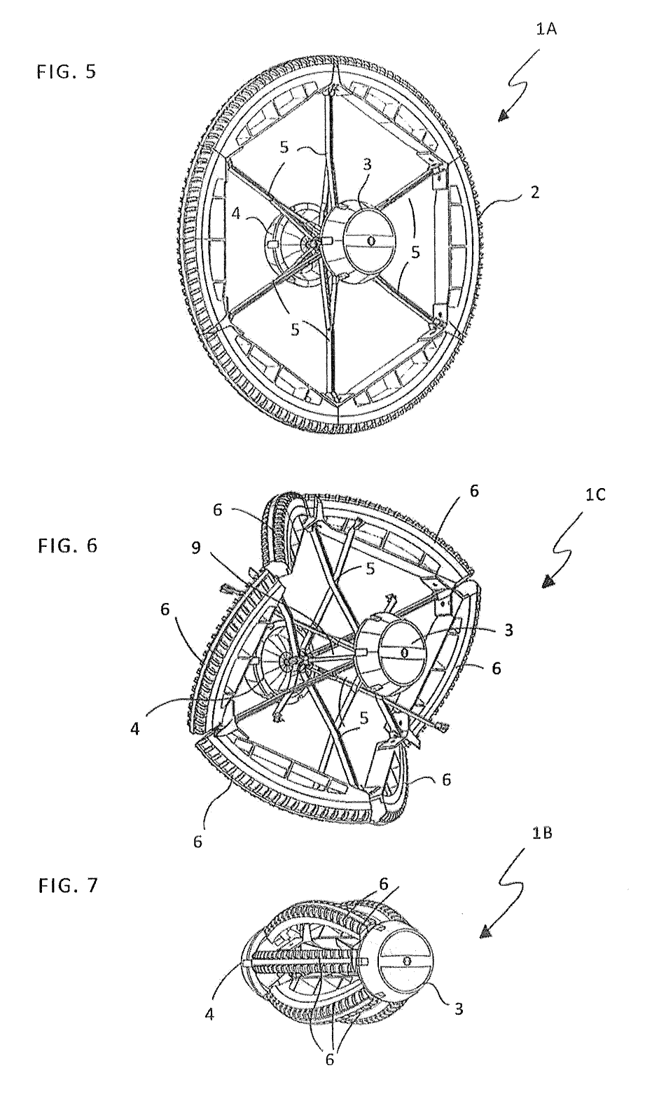

FIGS. 5, 6, 7 and 8, 9, 10 exemplify the passage of the wheel from the extended condition 1A (FIGS. 5 and 8) to the collapsed configuration 1B (FIGS. 7 and 10) passing through an intermediate configuration 1C (FIGS. 6 and 9), and vice versa, as follows. After unfolding the locking elements 15, 16 from the sectors 6 of the rim 2, the hubs 3, 4 are mutually axially moved apart by the extension of the central shaft 9, while the spokes 12, 13 of each group 5 simultaneously rotate with respect to each other in a scissor-like fashion (FIGS. 6, 9) until they are arranged substantially parallel to the central shaft 9 (FIGS. 7 and 10).

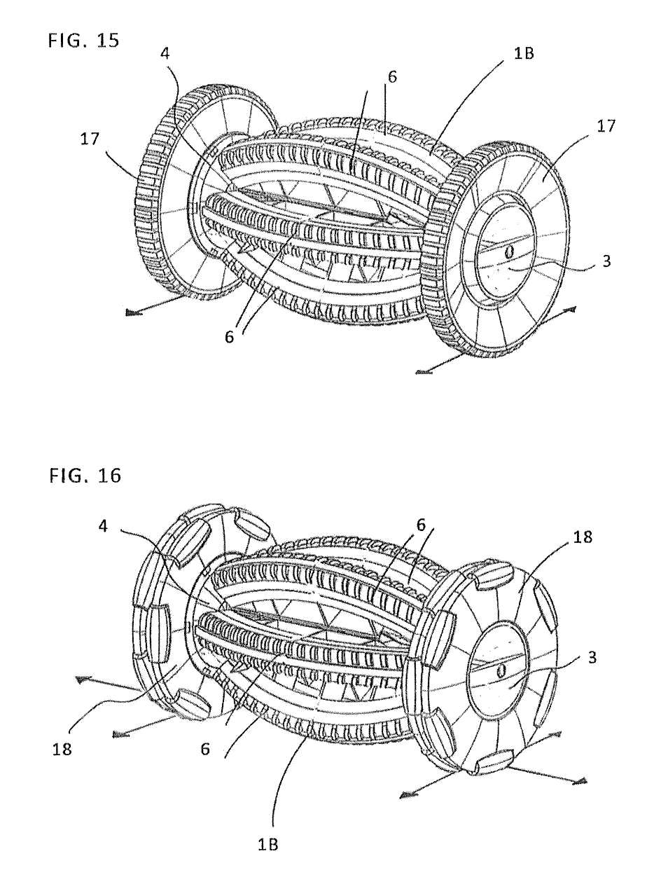

As observable in the collapsed condition of FIGS. 3, 4 and 7, the wheel 1B has an extremely small and compact overall dimension which facilitates manual transportation thereof, for example as represented in FIG. 18. However, given that the collapsed wheel 1B is evidently generally roller-shaped, it may also be rolled on the ground without necessarily having to be lifted. For this purpose, the invention provides for possible use of a pair of auxiliary rollers 17, represented in FIG. 15, selectively applicable to the hubs 3, 4. The rollers 17 are conveniently annular-shaped and are applicable on hubs 3, 4 through reversible fitting members non (not illustrated in detail) for example of the snap-coupling type.

The auxiliary rollers may also advantageously be of the omni-directional type, as indicated in the references 18 in the FIG. 16.

The foldable wheel according to the invention is susceptible to various applications on vehicles of various kinds and types, both in the extended and collapsed condition.

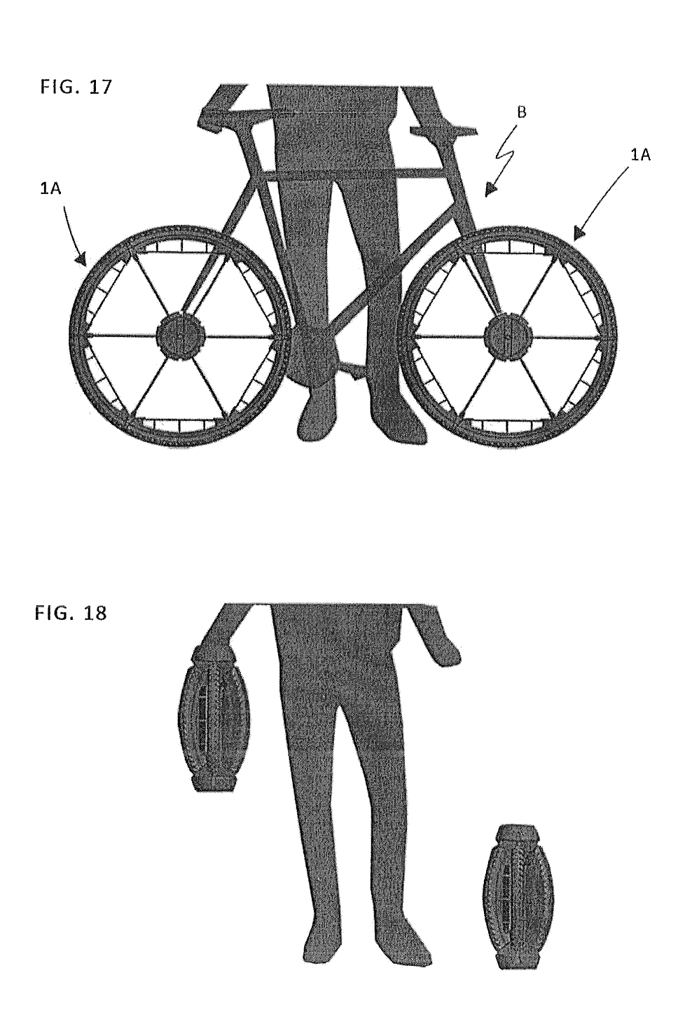

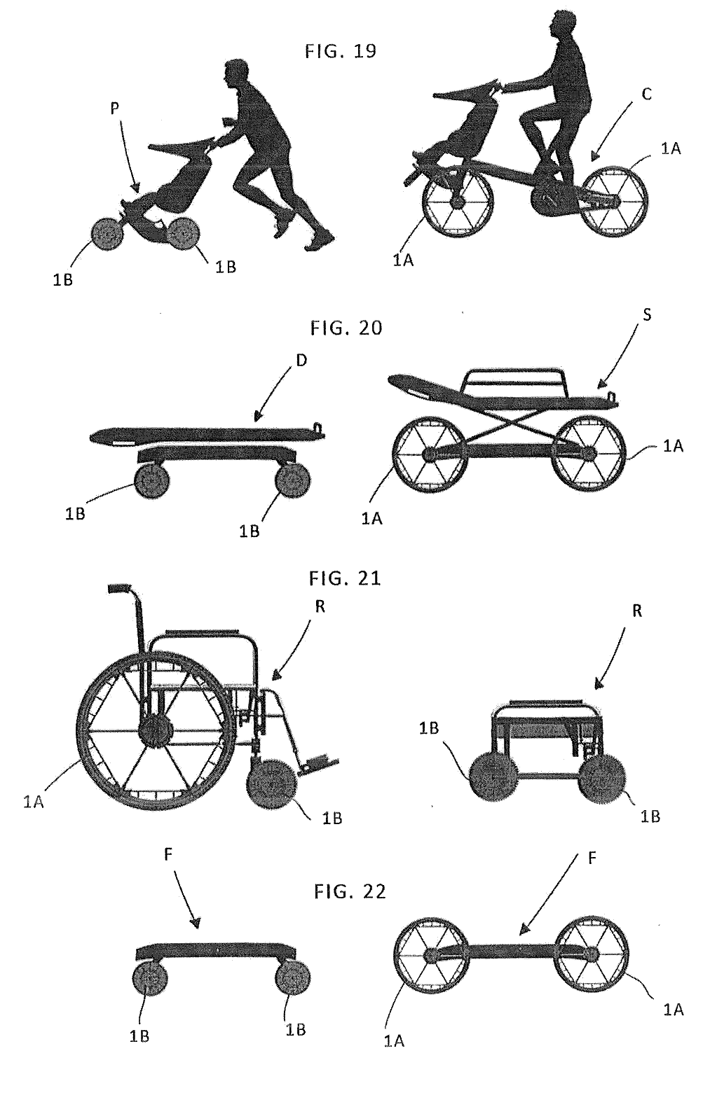

Thus, FIG. 17 shows the application of a pair of wheels, in extended condition 1A, to a bicycle B. In the case of FIG. 19 the same wheels 1A are applied to a bicycle C collapsible and transformable for example into a stroller P whose wheels 1B derive from the folding of the wheels 1A.

In the case of FIG. 20 the extended wheels 1A are applied to a first aid stretcher S, while the wheels in collapsed condition 1B are applied to a trolley D.

FIG. 21 represents the application to a foldable wheelchair R, and FIG. 22 to a drone or robot trolley F.

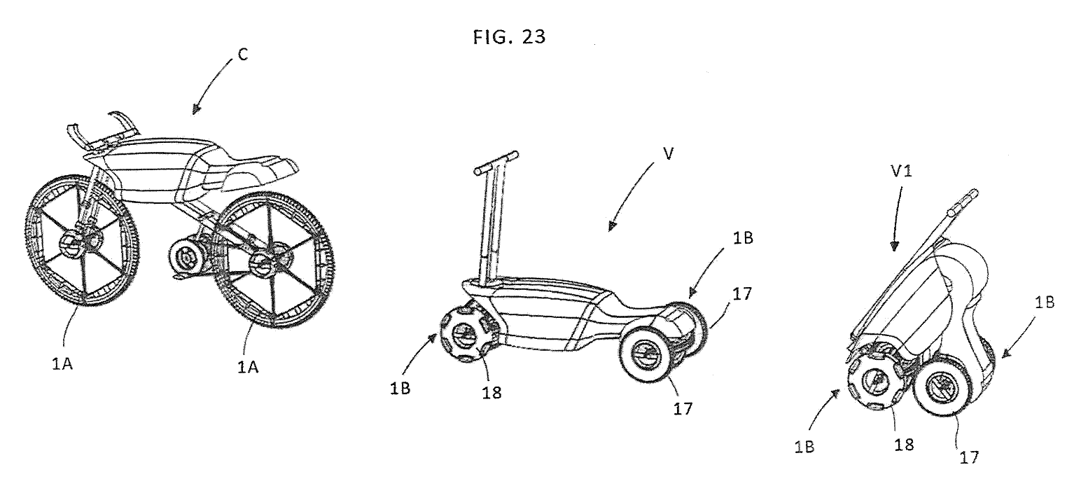

FIG. 23 shows the transformation of a collapsible vehicle, for example made up of an electrically driven cycle C, in a vehicle V, in which the wheels in extended condition 1A of the cycle C are arranged in the collapsed condition 1B and they are also provided with auxiliary wheels 17 and 18. In addition, the vehicle V is further collapsible in the configuration indicated with V1.

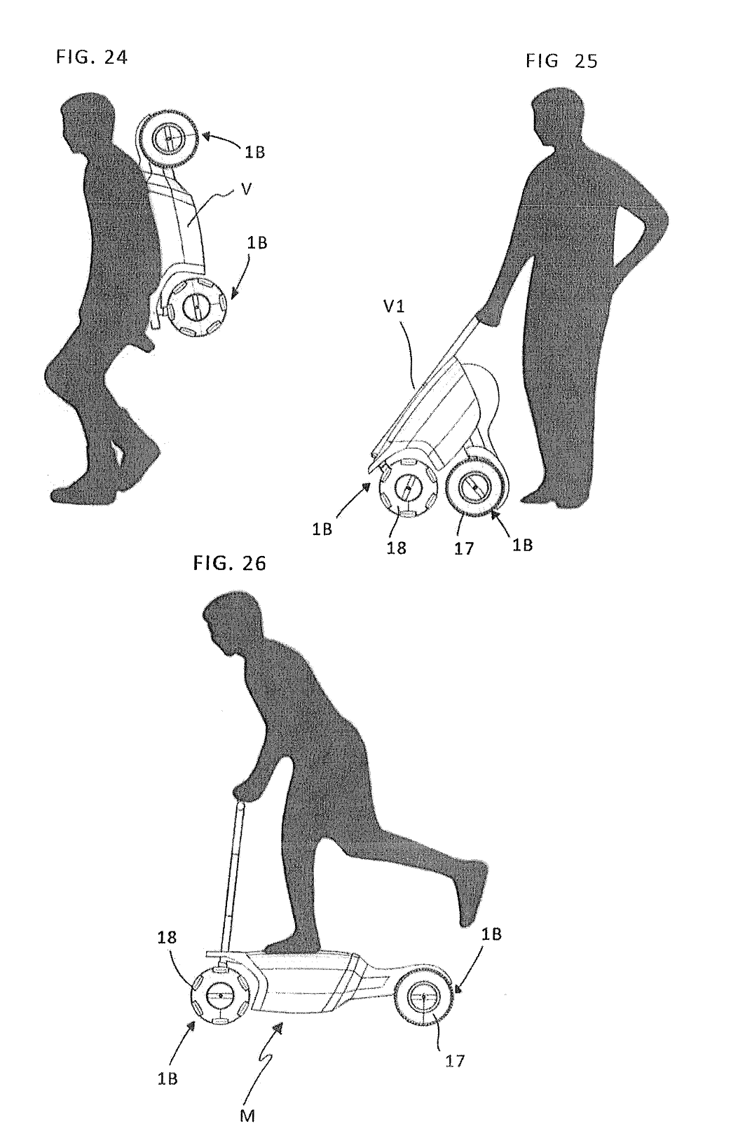

FIGS. 24 and 25 show how the motorised vehicle V can be comfortably carried on the shoulder and the collapsed motorised vehicle V1 moved like a trolley bag, and FIG. 26 shows the application of the wheels—in the collapsed condition and with the auxiliary rollers 17 and 18—to a scooter M.

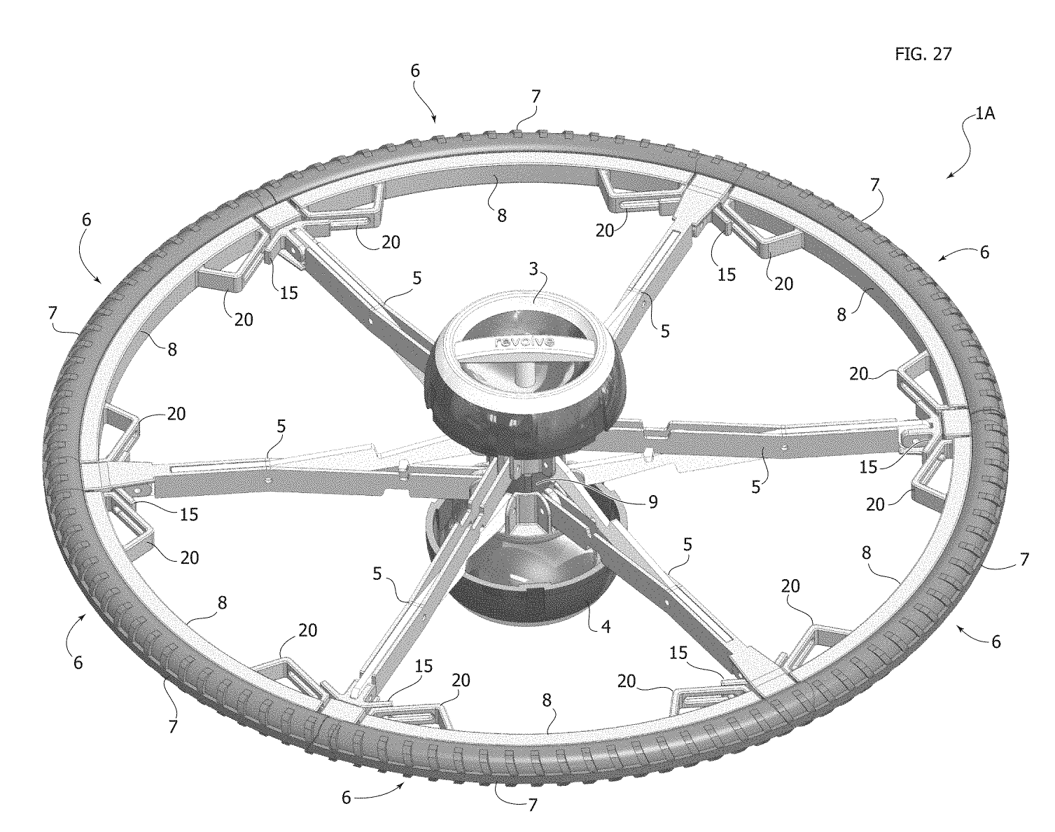

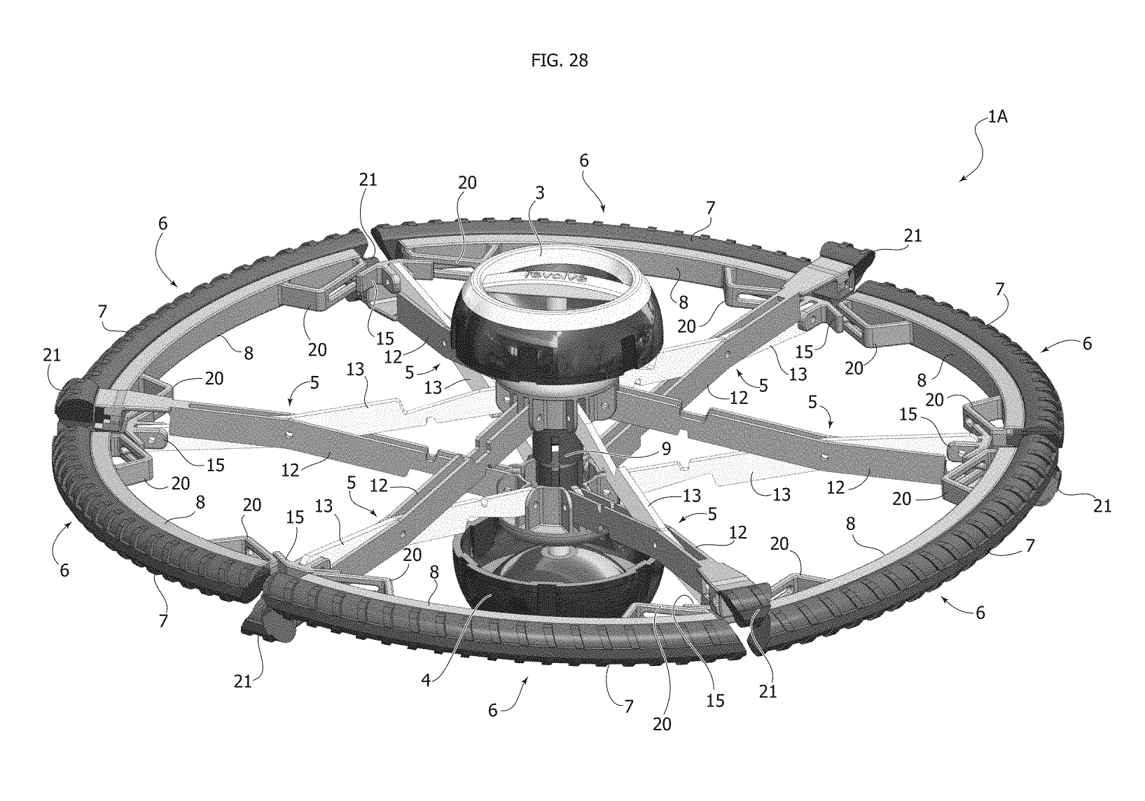

FIGS. 27-29, in which parts identical or similar to the ones described previously are indicated with the same reference numbers, show a variant of the foldable wheel according to the invention which is currently considered the preferred embodiment and differs from the solution described above substantially due to the following aspects.

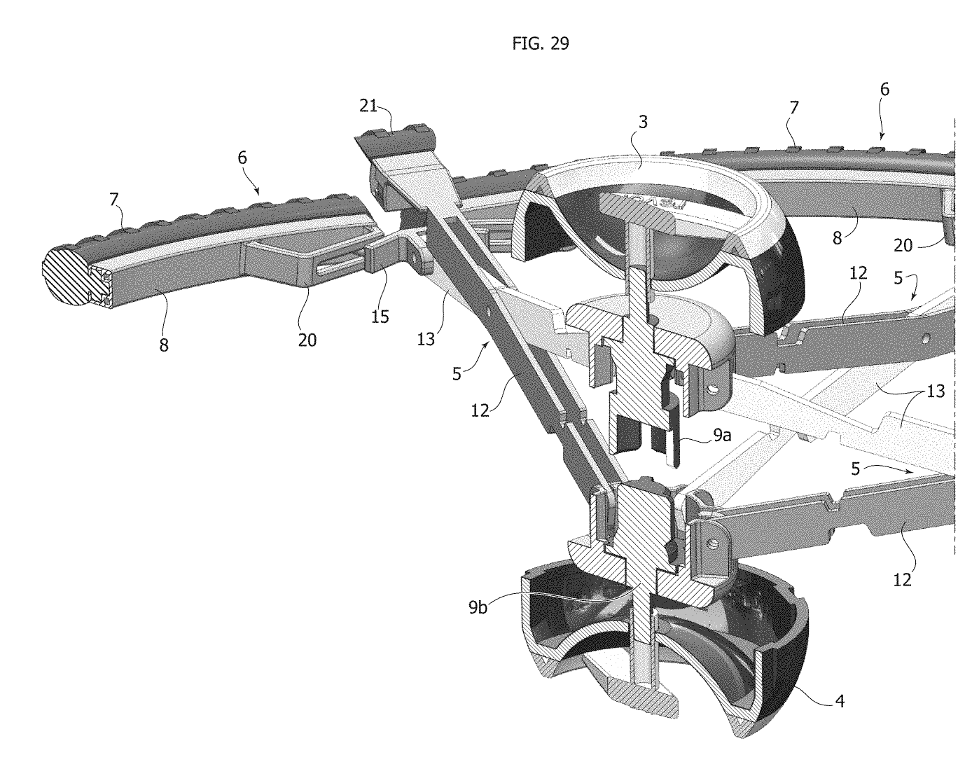

Firstly, the central shaft 9 on which the hubs 3, 4 are mounted is formed by two parts 9a, 9b axially separable from each other and each one of which is structured in an extensible and contractible telescopic fashion, as illustrated further in detail in FIG. 29. This solution enables advantageously further reducing the overall dimension of the wheel in the collapsed condition thereof due to the possibility of a greater capability to mutually move apart between the hubs 3 and 4.

Secondly, the locking members 15 cooperate with the guide tracks 20 fixed in the sectors 6 with the aim of making the rotational movement thereof between the extended and the collapsed conditions of the wheel more fluid.

Lastly, the spokes 5 are provided with projecting rubber lugs 21 suitable to be interposed, in the unfolded condition of the wheel, between every pair of contiguous sectors 6.

FIG. 29 shows—partly in detail—the parts 9a, 9b of the shaft 9, the guides 20 and the lug 21. Further shown is the distinctive cross-section of the rubber portions 7 engaged with the relative supports 8 of the sectors 6.

Obviously, the described applications are just examples of the various possible uses of the foldable wheel according to the invention, whose construction details and embodiments may widely vary with respect to what has been described and illustrated, without departing from the scope of protection of the present invention as defined in the claims that follow.

Thus, for example to the hubs 3, 4 there may be associated lateral modules that can be disassembled for the application of the auxiliary wheels 17 or 18, as well as possible pedals. In addition, in order to guarantee maximum stability of the wheel in the collapsed condition, the spokes 5 may also be provided with respective locking members.

1. A foldable wheel including
a double hub,
a rim formed of rubberized sectors (6), and
spokes pivotally connecting each hub with the sectors of the rim,
wherein the spokes have a fixed length and the sectors of the rim are configurable, starting from an extended condition forming the rim in which said hubs are set close to each other, in a collapsed condition in which said hubs are mutually spaced apart along the wheel axis and said spokes extend substantially parallel to the wheel axis and
the spokes pivoted to the hubs substantially on the wheel axis and in said collapsed condition said sectors of the rim extend longitudinally between said two hubs.

2. Foldable wheel according to claim 1, further comprising an axially extendable and contractible central shaft bearing said two hubs.

3. Foldable wheel according to claim 2, wherein the spokes are configured in groups in which each group includes a first spoke pivotally connecting one hub with a sector of the rim, and a second spoke pivotally interconnecting the other hub with said sector of the rim and is pivoted in a scissor-like fashion to the first spoke.

4. Foldable wheel according to claim 3, wherein the first and second spokes of each group have respective radially outer ends provided with locking members of the relative sector of the rim with respect to the contiguous sectors in the extended condition of the wheel.

5. Foldable wheel according to claim 3, wherein in the collapsed condition said spokes extend substantially parallel to the wheel axis within said sectors of the rim.

6. Foldable wheel according to claim 1, wherein in the collapsed condition the wheel has a substantially roller-like configuration.

7. Foldable wheel according to claim 1, wherein in the collapsed condition said two hubs are arranged to receive respective auxiliary lateral rollers.

8. Foldable wheel according to claim 7, wherein said auxiliary lateral rollers are of the omni-directional type.

9. Foldable wheel according to claim 1, wherein said sectors of the rim are six.

10. Foldable wheel according to claim 1, wherein the wheel equips in the extended condition a vehicle having two or more wheels.

11. Foldable wheel according to claim 1, wherein the wheel equips in the collapsed condition a vehicle having two or more wheels.

12. Foldable wheel according to claim 2, wherein said central shaft is made up of two parts separable from each other.

13. Foldable wheel according to claim 4, further comprising guide tracks fixed into said sectors and operatively associated to said locking means.

14. Foldable wheel according claim 1, wherein said spokes are provided with rubber lugs suitable to be interposed, in the unfolded condition of the wheel, between each pair of contiguous sectors.

15. A vehicle, provided with foldable wheels according to claim 1 in the extended condition and/or in the collapsed condition.
